(19) United States
(12) Patent Application Publication
(10) Pub. No.: US 2012/0263447 A1
(43) Pub. Date: Oct. 18, 2012

(54) ILLUMINATION DEVICE

(75) Inventor: Kent Fransson, Malmo (SE)

(73) Assignee: AXIS AB, Lund (SE)

(21) Appl. No.: 13/444,894

(22) Filed: Apr. 12, 2012

Related U.S. Application Data
(60) Provisional application No. 61/476,057, filed on Apr. 15, 2011.

(30) Foreign Application Priority Data
Apr. 13, 2011 (EP) 11162211.4

(51) Int. Cl. G03B 15/03

(52) U.S. Cl. 396/164

(57) ABSTRACT

An illumination device and method for illuminating a scene monitored by a camera uses a plurality of light emitting elements and an illumination control unit. The illumination control unit is arranged to individually control the output intensity of the plurality of light emitting elements based on a camera view direction setting, such that illumination is provided in a view direction of the camera.

### CROSS-RELATED APPLICATIONS

This application claims priority to U.S. Provisional Application No. 61/476,057 filed on Apr. 15, 2011 and EPC application 11162211.4 filed on Apr. 13, 2011, which are incorporated by reference as if fully set forth.

### TECHNICAL FIELD

The present invention relates to an illumination device for illuminating a scene monitored by a camera, and to a method of illuminating a scene monitored by a camera.

### BACKGROUND ART

Surveillance cameras used to monitor a specific setting may from time to time need additional lighting to be able to give a good picture of the environment that they are used to monitor. This is for instance the case during night time in an outdoor setting when the natural light is insufficient for the camera or in an indoor situation when, e.g. for energy saving purposes, the lights are switched off. Some type of lighting can then be used in combination with the surveillance camera. A common choice is to use light emitting diodes, LEDs, emitting infrared or white light, for illuminating the scene which is monitored by the surveillance camera. The LEDs may be mounted in external units or integrated in the camera housing or the camera's mechanical structure.

In a camera having a movable camera head that can pan, tilt, and zoom, a so called PTZ camera, it is of interest that the illumination is able to cover the different viewing angles of the camera head. This can be solved by mounting the LEDs on the camera head so that the illumination follows the movement of the camera head and points in the viewing direction of the camera head.

However, a problem when mounting the LEDs on the camera head is that the LEDs will then be closely placed to the imaging sensor, which in turn means that the heat generated by the LEDs can negatively impact the performance of the imaging sensor. Disturbing reflections when the LEDs are placed close to the camera lens is another problem which may occur when the LEDs are mounted on the camera head. The LEDs also make the camera head bulkier and puts additional requirements on the cabling connecting the base of the camera with the camera head for current feed and control of the LEDs.

One way to reduce the heat which the imaging sensor is exposed to is to place the LEDs used for illumination further away from the imaging sensor and not on the movable camera head, but instead on the base of the camera.

However, a problem occurring when the LEDs are mounted on the camera base is that the illumination of the LEDs then need to cover all possible viewing angles of the camera head. Illuminating the whole scene implies that a large number of LEDs is needed and that a large amount of input power is needed to operate the LEDs, this in turn generating more heat.

Thus, there is a need for an improved illumination solution for surveillance cameras.

### SUMMARY OF THE INVENTION

A method and system provide an illumination solution that alleviates the above problems regarding heat generation and power consumption, and provide an illumination solution where the illumination provided by an illumination device may be efficiently controlled to match the need for illumination for a camera.

According to embodiments described herein, an illumination device for illuminating a scene monitored by a camera comprises a plurality of light emitting elements, and an illumination control unit, wherein the illumination control unit is arranged to individually control the output intensity of the plurality of light emitting elements based on a camera view direction setting, such that illumination is provided in a view direction of the camera. This makes it possible to adapt the illumination to the needs of the camera, in order to obtain a better quality picture, while at the same time reducing the power consumption and the generated heat.

The camera view direction setting may comprise a camera pan position. This gives an easily obtainable indication of where the camera is pointed and in which direction illumination is needed.

Additionally, the illumination control unit may be arranged to control the plurality of light emitting elements based on a camera field of view setting. In this manner, the illumination device may be controlled to give a wider angle of illumination, e.g. by increasing the output intensity of a larger number of light emitting elements, when a wide angle lens is used or the camera zoom lens setting indicates a wide angle setting, and vice versa when a telephoto lens or setting is used. This makes it possible to even better adapt the illumination to the needs of the camera.

The camera may comprise a camera head mounted on a camera base, and the light emitting elements may be mounted on the camera base. This provides a larger distance between the image sensors in the camera head and the light emitting elements, which means that the image sensors are exposed to less heat from the light emitting elements. Mounting the light emitting elements on the camera base also has the advantage of reducing any disturbing reflections which may occur when light emitting elements are placed close to the camera lens.

The camera may have a movable camera head. The output of the illumination device may then be adapted dynamically to the view direction of the camera.

The light emitting elements may be mounted in a ring-shape or partial ring shape, surrounding at least part of the camera head. In this way it is possible to easily cover all different camera view directions. It also simplifies and reduces the cost of production and assembly of the illumination device on the camera. In a case when it is known that the camera view direction will only be in a certain span, it is possible to only mount light emitting elements in a partial ring shape, covering only those directions that are of interest. This embodiment may be particularly useful for a horizontally or mainly horizontally mounted camera.

Alternatively, the light emitting elements may be mounted along a horizontal line having a vertical curve corresponding to a camera pan position span. In this way the illumination may be efficiently directed in the view direction of the camera. This could be a useful option for a vertically or mainly vertically mounted camera.

The light emitting elements may be light emitting diodes, LEDs, this providing a space, cost and power efficient choice. The LEDs may be adapted to emit radiation in the infra-red or near infra-red spectrum, which is useful when the camera is used for capturing images in a dark setting, e.g., during night time.

The light emitting elements may be arranged into groups, and the illumination control unit may be arranged to jointly control the light emitting elements within each group. This provides an efficient control of the light emitting elements, reducing the amount of control information to be handled by the control unit.

A method of illuminating a scene monitored by a camera comprises the steps of providing a plurality of light emitting elements, and individually controlling the output intensity of the plurality of light emitting elements based on a camera view direction setting, such that illumination is provided in a view direction of the camera.

Information regarding the camera view direction setting may be received from position sensors arranged for determining the camera view direction setting. Alternatively or additionally, information regarding the camera view direction setting may be received from a camera control unit arranged to control the camera view direction setting. Alternatively or additionally, the camera view direction setting may be determined based on image processing of an image captured by the camera.

As a further option, information regarding ambient light intensity may be received, and the plurality of light emitting elements may be controlled such that a total output intensity of the illumination device is lowered if the ambient light intensity exceeds a predetermined level. This makes it possible to even further adapt the illumination provided by the illumination device to the needs of the camera so that as good a picture as possible is obtained. By reducing the output intensity to the level needed in addition to the ambient light, the power consumption and heat generation can be even further reduced. In addition, the risk of producing an overexposed picture is also lowered.

### BRIEF DESCRIPTION OF THE DRAWINGS

A more detailed understanding may be had from the following description, given by way of example in conjunction with the accompanying drawings wherein:

FIG. 1 shows a side view of a horizontally mounted camera;

FIG. 2 shows the camera of FIG. 1 from above;

FIG. 3 shows the camera in a side view when mounted vertically;

FIG. 4 shows a side view of an embodiment of an illumination device according to the invention; and

FIG. 5 is a flow chart illustrating a method according to embodiments of the invention.

### DETAILED DESCRIPTION

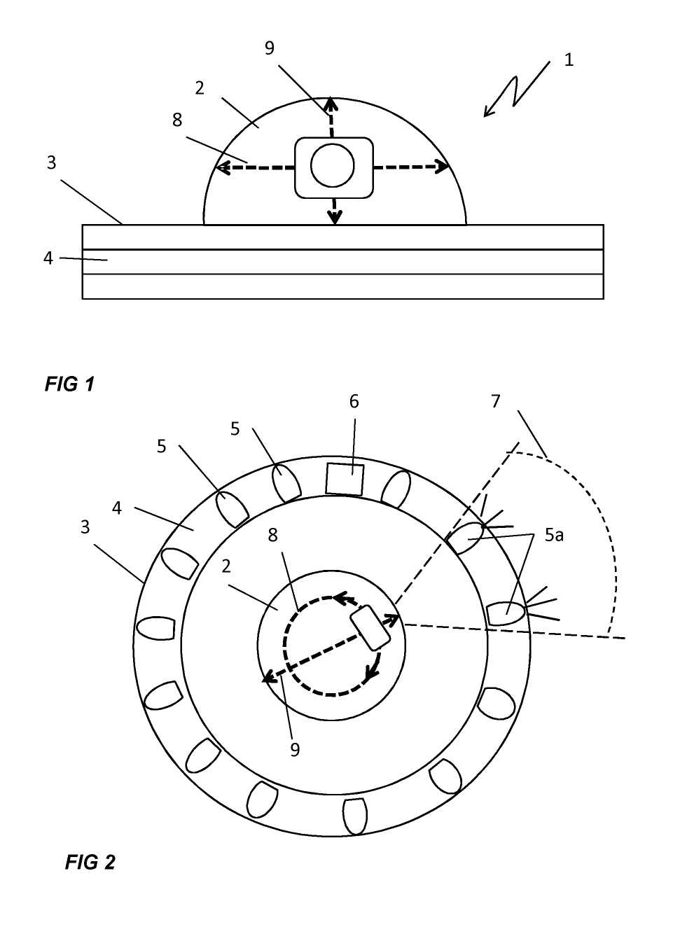

In FIGS. 1 and 2, a camera 1 having a dome-shaped camera head 2 mounted on a circular camera base 3 is shown. The camera is equipped with an illumination device 4. As shown in FIG. 2, the illumination device 4 comprises a numbers of light emitting elements 5, e.g., in the form of LEDs, mounted on the camera base 3. The light emitting elements 5 may be emitting light in the visible or non-visible spectrum. As one example, they may be designed for emitting in the infra-red or near infra-red spectrum, and it may be noted that both for visible and non-visible radiation, LEDs are just one example of light emitting elements which could be used. Other possible choices include but are not limited to light bulbs, halogen lamps and gas discharge lamps. The light emitting elements 5 are mounted along the circumference of the camera base 3 and surround the camera head 2. The light emitting elements may be mounted in a ring-shape or partial ring shape, in one or more rows, surrounding at least part of the camera head. The light emitting elements may also be mounted in any suitable position outside the camera base 2, for instance on a separate structure.

The illumination device 4 also comprises a control unit 6, which controls the operation of the light emitting elements 5. Physical connections between the light emitting elements 5 and the control unit 6 are not shown on the drawings for the sake of clarity. This control unit may be implemented in software or hardware, and the position on the drawings is not in any way to be seen as limiting. It may for instance be implemented as part of software and/or hardware controlling the camera 1.

The camera 1 may be a so called PTZ surveillance camera, i.e., a surveillance camera able to pan, tilt and zoom. To this end, the camera head 2 is movable in relation to the camera base 3. “Movable” should be interpreted in the widest possible sense, e.g., an operator may turn the camera head 2 by hand or the camera head movement may be motorized and controlled by inputting a chosen view direction via a user interface. Further, the camera head 2 may be moved based on a pre-set guard tour, or it may be moved based on some other type of input, such as from motion sensors or heat detectors sensing that an object has entered in a possible view direction of the camera 1 and the camera 1 is then pointed in that direction.

The position of the camera head 2 in relation to the camera base 3 may also be set once and for all during set-up of a surveillance camera, and the illumination device may then use the same view direction settings during its entire life span. This may lead to the situation of not using certain light emitting elements, but this may still be more cost efficient than to design and assemble an adapted illumination device.

Assuming that the camera 1 in FIGS. 1 and 2 is horizontally mounted, changing the pan position of the camera 1 will move the view angle 7 along a horizontal circle. In FIG. 2, the camera of FIG. 1 is shown from above (or, as it may be, from below if the camera is mounted in a ceiling, for example), and when the camera pans, the camera head 2 is turned along a circle 8 in turn rotating the camera view angle 7 so that the camera 1 may scan the surrounding environment 360°.

In a tilt motion, the camera 1 instead moves its view angle 7 in a vertical direction, e.g., upwards or downwards, along the line 9. The pan and tilt motions may obviously be combined.

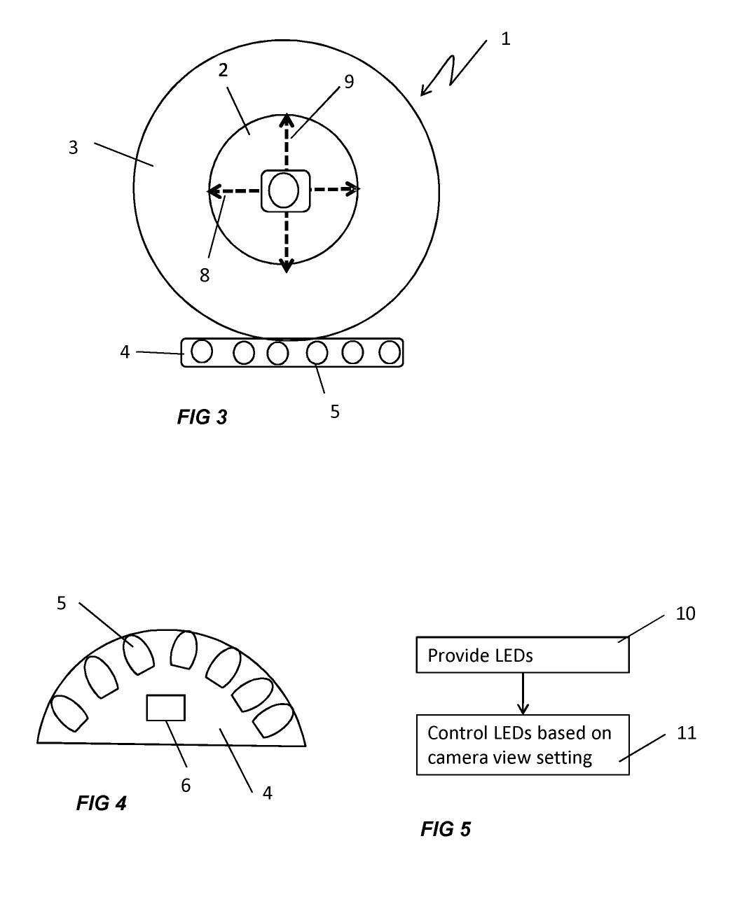

For a vertically mounted camera, as shown in FIGS. 3 and 4, the camera head 2 turns from left to right and vice versa in order to make the camera view angle move along the horizontal line 8 when the camera 1 pans. When the camera head 2 tilts, it moves the view angle upwards or downwards, along the vertical line 9. Also, here the pan and tilt motions may be combined in any suitable manner.

For the vertically mounted camera 1, the light emitting elements 5 of the illumination device 4 may as shown in FIG. 4 be mounted on a curved or arched shape, e.g. on a vertical line along a dome-shaped or an arch-shaped structure. For sake of simplicity, this is shown below the camera base in FIG. 3, but it may be placed in any convenient position on or beside the camera base. It may also be part of the camera base 3. The position of the illumination device may enable coverage of all different camera view directions, or selected parts thereof.

It may be noted that the terms vertical and horizontal are to be interpreted as including a reasonable deviation from the vertical or horizontal plane. As an example, a deviation of 20° from the vertical or horizontal plane would not in any major way affect the operation and applicability of illumination device as presented herein. These terms may also be read as essentially vertical or essentially horizontal, but for sake of simplicity, the terms horizontal and vertical are used throughout this description. When the camera 1 is used in a poorly lit surrounding, extra illumination may be needed in order to get a good picture of any objects in the environment. This illumination may be provided by the illumination device 4. In order to lower the power consumption and reduce the heat generated by the illumination device 4, the output of the light emitting elements 5 is individually controllable based on the camera view direction settings, e.g., such that only those light emitting elements that are useful for illuminating the objects currently viewed by the camera are lit. As one example, the pan position along the circle 8 of the camera head 2 may be used as input to the control unit 6.

The camera view direction setting, e.g., in the form of a pan position, may be obtained from position sensors which are arranged for determining the camera view direction settings. Such position sensors may, for instance, be placed such that they sense the position of a motor, which moves the camera head 2. If a manually moveable lens is used, position sensors may be arranged to sense the physical position of the lens.

Information regarding the camera view direction setting may also be obtained from a camera control unit, which also may be adapted to control the view direction of the camera. This camera control unit may, for example, base its view direction control on input from an operator, from information on a pre-set guard tour, or from some type of sensors, such as motion sensors or heat detection sensors. The camera control unit may then control both the camera 1 and the illumination device 4 to certain directions.

As a further option, advanced image processing can be used on the image captured by the camera to determine the view direction setting of the camera and where the illumination is needed. For instance, if the image processing gives as a result that the camera is currently monitoring one of a number of different areas in a room, the illumination device may then use that information to direct the illumination towards that area. The image processing may take place in the illumination control unit 6, or e.g. in a external unit which extracts relevant camera view direction settings for the illumination control unit.

As a further alternative, an operator may input the camera view direction setting to the illumination control unit. This could for instance be the case when a movable camera head is manually moved to a certain view direction at the time of installation and where the operator indicates the camera view direction setting on a monitoring screen in a control tool, as input to the illumination control unit.

It is also possible to use the camera field of view, e.g. in the form of a camera field of view setting, such as a setting of a zoom lens in the camera, as input to the control unit 6. When the zoom setting of the camera 1 indicates that a wide angle view is used, a wider range of light emitting elements 5 may be used, and when a telephoto setting is used, which indicates that a smaller viewing angle is used, fewer light emitting elements 5 may be used. An alternative to this, which is applicable e.g. when interchangeable lenses are used in the camera, is to control the illumination device 4 so that the use of a wide angle or a fish eye lens means that a wider range of light emitting elements 5 are used, and the use of a telephoto lens means fewer light emitting elements 5 are activated.

It may be noted that the light emitting elements 5 may be activated or inactivated separately, independent of other light emitting elements 5. In some instances, the light emitting elements 5 may be grouped into groups of three elements, for example, and the elements in each group may be jointly controlled.

FIG. 2 illustrates one example of how the light emitting elements 5a, which provide illumination in the view direction of the camera 1, are lit. In FIG. 2, the remaining light emitting elements 5 are not lit. It is also possible to adjust the output intensity of the light emitting elements 5, e.g., such that those elements that are close to the view direction are lit to say half their maximum strength, thus providing softer illumination along the border of the picture captured by the camera 1. It is also possible to only reduce the strength of radiation from such light emitting elements that are not pointing in the view direction of the camera and to not entirely inactivate them. The power savings and heat reduction will then be slightly less for obvious reasons.

The same principles apply to the illumination device 4 as shown in FIGS. 3 and 4. In this case, the pan position along the line 8 may be used in the same manner as for the horizontally mounted camera for controlling the light emitting elements 5, such that those elements along the curve-shape that point in the view direction of the camera are lit.

It may be noted that the illumination device 4 may comprise further light emitting elements 5 adapted for directing light in different tilt directions, in case this would be useful. Such an illumination device 4 could then comprise a number of light emitting elements 5 mounted along a vertical line in a curve-shape which corresponds to the different tilt positions of the camera 1. Another way of ascertaining that the illumination covers the tilt position of the camera 1 is to choose light emitting elements 5 which have such an angle of illumination that the desired tilt range is covered.

FIG. 5 illustrates a method according to the embodiments of the invention. In a first step 10, a plurality of light emitting elements, e.g., in the form of LEDs, are provided. In a second step 11, the output intensity of these light emitting elements are controlled based on a camera view setting, such that illumination is provided in a view direction of the camera. The view direction setting may, as described above, comprise a pan position of the camera head. In addition to the view direction setting, a field of view setting, such as a zoom setting or zoom value of a zoom lens in the camera, may also be used as described previously.

It may be noted that information regarding the level of intensity of the ambient light may also be used as input for controlling the light emitting elements 5. As an example, when the camera 1 is used in low light conditions, such as during dusk or dawn, the ambient light alone might not be strong enough for the camera 1 to maintain a proper quality of the captured image, but it may still be possible to lower the output intensity of the illumination device 4, e.g., by lighting only every second element or every third element that is directed for illumination in the camera view direction, or by lowering the output intensity of selected light emitting elements. This makes it possible to maintain a good image quality, while achieving reductions in power consumption and heat generation.

Using information on the ambient light intensity may also help in reducing the risk of the camera capturing an overexposed picture. Other inputs on which the control unit may base its control of the light emitting elements include, for example, the focal distance used in the camera, the exposure time, and the gain. The ambient temperature may also be used as a parameter when deciding the light intensity, since at lower ambient temperatures, the system will be able to withstand more heat produced by the illumination device without any negative effects and, thus, higher illumination intensity may be applied. At higher ambient temperatures, the opposite would apply. Further input parameters for the illumination control unit may also be available.

1. A camera, having an illumination device, the camera comprising:
a plurality of light emitting elements; and
an illumination control unit;
wherein the illumination control unit is arranged to individually control the output intensity of the plurality of light emitting elements, and is arranged to individually control the output intensity of the plurality of light emitting elements based on a camera view direction setting including a camera pan position, such that illumination is provided in a view direction of the camera.

2. The camera according to claim 1, wherein the illumination control unit is additionally arranged to individually control the plurality of light emitting elements based on a camera field of view setting.

3. The camera according to claim 1, wherein the camera comprises a camera head mounted on a camera base, and wherein the light emitting elements are mounted on the camera base.

4. The camera according to claim 3, wherein the camera head is movable.

5. The camera according to claim 3, wherein the light emitting elements are mounted in a ring-shape or partial ring shape, surrounding at least part of the camera head.

6. The camera according to claim 1, wherein the light emitting elements are mounted along a horizontal line having a vertical curve corresponding to a camera pan position span.

7. The camera according to claim 1, wherein the light emitting elements are light emitting diodes.

8. The camera according to claim 1, wherein the light emitting elements are adapted to emit radiation in the infra-red or near infra-red spectrum.

9. The camera according to claim 1, wherein the light emitting elements are arranged into groups, and wherein the illumination control unit is arranged to jointly control the light emitting elements within each group.

10. A method of illuminating a scene monitored by a camera, comprising:
providing a plurality of light emitting elements;
individually controlling the output intensity of the plurality of light emitting elements based on a camera view direction setting including a camera pan position, such that illumination is provided in a view direction of the camera.

11. The method according to claim 10, further comprising:
receiving information regarding the camera view direction setting from position sensors arranged for determining the camera view direction setting.

12. The method according to claim 10, further comprising:
receiving information regarding the camera view direction setting from a camera control unit arranged to control the camera view direction setting.

13. The method according to claim 10, further comprising:
determining the camera view direction setting based on image processing of an image captured by the camera.

14. The method according to claim 10, further comprising:
receiving information regarding ambient light intensity; and
controlling the plurality of light emitting elements such that a total output intensity of the illumination device is lowered if the ambient light intensity exceeds a predetermined level.
